(19) United States
(12) Patent Application Publication
(10) Pub. No.: US 2021/0329648 A1
(43) Pub. Date: Oct. 21, 2021

(54) USER EQUIPMENT AND BASE STATION APPARATUS

(71) Applicant: NTT DOCOMO, INC., Tokyo (JP)

(72) Inventors: Ryosuke Osawa, Chiyoda-ku, Tokyo (JP); Shaozhen Guo, Beijing, Haidian District, (CN); Huan Wang, Beijing, Haidian District (CN); Xiaolin Hou, Beijing, Haidian District, (CN)

(73) Assignee: NTT DOCOMO, INC., Tokyo (JP)

(21) Appl. No.: 17/273,239

(22) PCT Filed: Sep. 11, 2018
(86) PCT No.: PCT/JP2018/033666

§ 371 Date: Mar. 3, 2021

(51) Int. Cl. H04W 72/04; H04L 1/16; H04W 4/40

(52) U.S. Cl. CPC H04W 72/0493; H04W 72/042; H04W 4/40; H04L 1/1614; H04W 72/0446

(57) ABSTRACT

A user equipment includes a receiving unit that receives information indicating a resource to be used for inter-terminal direct communication; and a transmitting unit that executes a transmission in the inter-terminal direct communication based on the information indicating the resource, wherein the information indicating the resource is a semi-static UE (User Equipment) dedicated configuration or a dynamic configuration that includes information in which the resource to be used for the inter-terminal direct communication is overwritten on an uplink resource or a flexible resource that is to be time division multiplexed in a semi-static UE common configuration.

### TECHNICAL FIELD

The present invention relates to user equipment and a base station apparatus in a radio communication system.

### BACKGROUND ART

For LTE (Long Term Evolution) and LTE successor systems (e.g., LTE-A (LTE Advanced), NR (New Radio) (which is also referred to as 5G), D2D (Device to Device) technology has been studied in which units of user equipment directly communicate without going through a base station apparatus (e.g., Non-Patent Document 1).

D2D reduces traffic between user equipment and a base station apparatus, and D2D allows communication between units of user equipment, even if a base station apparatus is unable to communicate during a disaster or the like. In 3GPP (3rd Generation Partnership Project), D2D is referred to as “sidelink.” However, in this specification, a more generic term, D2D, is used. Note that, in the embodiments described below, “sidelink” is also used, if necessary.

D2D communication is broadly classified into D2D discovery (which may also be referred to as D2D discovery or D2D detection) for detecting another unit of user equipment that is capable of communicating; and D2D communication (which may also be referred to as D2D direct communication, D2D communication, inter-terminal direct communication, or the like) for direct communication between units of user equipment. In the following, if D2D communication, D2D discovery, and the like are not particularly distinguished, they are simply referred to as D2D. Furthermore, signals transmitted and received in D2D are referred to as D2D signals. Various use cases of services related to NR V2X (Vehicle to Everything) have been studied (e.g., Non-Patent Document 2).

### RELATED ART DOCUMENT

### Non-Patent Document

Non-Patent Document 1: 3GPP TS 36.211 V15.2.0(2018-06)
Non-Patent Document 2: 3GPP TR 22.886 V15.1.0(2017-03)

### SUMMARY OF THE INVENTION

### Problem to be Solved by the Invention

When a resource used in D2D communication is configured in a band common to a resource to be used for uplink and downlink, a method is required that is for flexibly configuring the resource according to a characteristic of required traffic.

The present invention has been accomplished in view of the above-described point, and an object is to flexibly configure a resource to be used by a user equipment in inter-terminal direct communication.

### Means for Solving the Problem

According to the disclosed technology, there is provided a user equipment including a receiving unit that receives information indicating a resource to be used for inter-terminal direct communication; and a transmitting unit that executes a transmission in the inter-terminal direct communication based on the information indicating the resource, wherein the information indicating the resource is a semi-static UE (User Equipment) dedicated configuration or a dynamic configuration that includes information in which the resource to be used for the inter-terminal direct communication is overwritten on an uplink resource or a flexible resource that is to be time division multiplexed in a semi-static UE common configuration.

### Advantage of the Invention

According to the disclosed technology, a resource to be used by a user equipment can be flexibly configured in inter-terminal direct communication.

### BRIEF DESCRIPTION OF DRAWINGS

FIG. 1 is a diagram illustrating V2X;

FIG. 2 is a diagram for illustrating an example of a resource configuration in an embodiment of the present invention;

FIG. 3 is a diagram illustrating an example (1) of a resource configuration in an embodiment of the present invention;

FIG. 4 is a diagram illustrating an example (2) of a resource configuration in an embodiment of the present invention;

FIG. 5 is a diagram illustrating an example (3) of a resource configuration in an embodiment of the present invention;

FIG. 6 is a diagram illustrating an example (4) of a resource configuration in an embodiment of the present invention;

FIG. 7 is a diagram illustrating an example (5) of a resource configuration in an embodiment of the present invention;

FIG. 8 is a diagram illustrating an example (6) of a resource configuration in an embodiment of the present invention;

FIG. 9 is a diagram illustrating an example (7) of a resource configuration in an embodiment of the present invention;

FIG. 10 is a diagram illustrating an example (1) of a communication sequence in an embodiment of the present invention;

FIG. 11 is a diagram illustrating an example (2) of a communication sequence in an embodiment of the present invention;

FIG. 12 is a diagram illustrating an example of a functional configuration of a base station apparatus 10 according to an embodiment of the present invention;

FIG. 13 is a diagram illustrating an example of a functional configuration of a user equipment 20 according to an embodiment of the present invention; and

FIG. 14 is a diagram illustrating an example of a hardware configuration of the base station apparatus 10 and the user equipment 20 according to an embodiment of the present invention.

### EMBODIMENTS OF THE INVENTION

In the following, embodiments of the present invention are described by referring to the drawings. The embodiments described below are an example, and embodiments to which the present invention is applied are not limited to the following embodiments.

In an operation of a radio communication system of the embodiments of the present invention, existing technology is appropriately used. Here, the existing technology is, for example, existing LTE but not limited to existing LTE. Further, the term “LTE” used in this specification has a broad meaning including LTE-Advanced, a system subsequent to LTE-Advanced (for example, NR) or a wireless LAN (Local Area Network) unless as otherwise specified.

In the embodiments of the present invention, a duplex method may be a TDD (Time Division Duplex) method, an FDD (Frequency Division Duplex) method, or any other method (e.g., Flexible Duplex, etc.).

In the following description, a method of transmitting a signal using a transmission beam may be digital beam forming of transmitting a signal (pre-coded with a pre-coding vector) multiplied by a pre-coding vector or may be analog beam forming for implementing beam forming using a variable phase shifter in a radio frequency (RF) circuit. Similarly, a method of receiving a signal using a reception beam may be digital beam forming of multiplying a received signal by a predetermined weight vector or may be analog beam forming of implementing beam forming using a variable phase shifter in a RF circuit. Hybrid beam forming in which digital beam forming and analog beam forming are combined may be applied to transmission and reception. Furthermore, transmitting a signal using a transmission beam may be transmitting a signal through a specific antenna port. Similarly, receiving a signal using a reception beam may be receiving a signal through a particular antenna port. An “antenna port” refers to a logical antenna port or a physical antenna port defined in the 3GPP standard. In addition, a precoding or the beam forming is also referred to as a “pre-coder” or a “spatial domain filter.”

A method of forming the transmission beam and the reception beam is not limited to the above-described methods. For example, in a base station apparatus 10 or a user equipment 20, which are included in the radio communication system according to an embodiment of the present invention, provided with a plurality of antennas, a method of changing an angle of each antenna may be used, a method in which a method using a precoding vector and a method of changing an angle of an antenna are combined may be used, a method of switching and using different antenna panels may be used, a method of using a combination of a plurality of antenna panels may be used, or any other method may be used. Furthermore, for example, a plurality of different transmission beams may be used in a high frequency band. Using a plurality of transmission beams is referred to as a multi-beam operation, and using a single transmission beam is referred to as a single beam operation.

Furthermore, in an embodiment of the present invention, when a radio parameter or the like is “configured”, it may mean that a predetermined value is “pre-configured” or it may mean that a radio parameter provided by notification from the base station apparatus 10 or the user equipment 20 is configured.

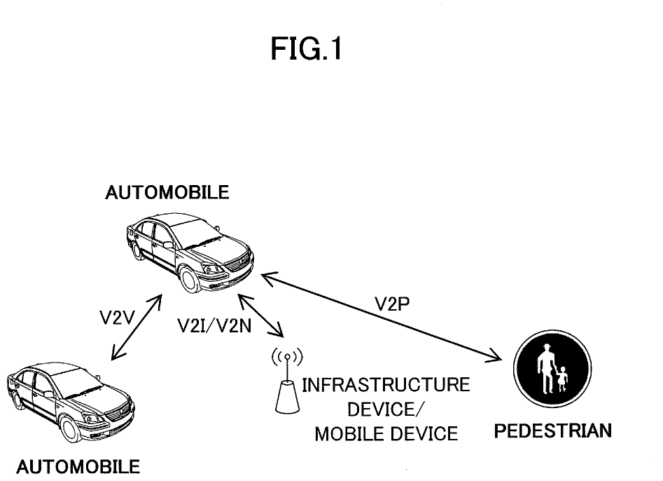

FIG. 1 is a diagram for illustrating V2X. In 3GPP, implementing vehicle to everything (V2X) or enhanced V2X (eV2X) by extending a D2D function is under review, and technical specification documentation development thereof is in progress. As illustrated in FIG. 1, V2X is a part of intelligent transport systems (ITS) and is a generic term of vehicle to vehicle (V2V) meaning a communication form performed between vehicles, vehicle to infrastructure (V2I) meaning a communication form performed between a vehicle and a road-side unit (RSU) installed on a road side, vehicle to Nomadic device (V2N) meaning a communication mode performed between a vehicle and a mobile terminal carried by the driver, and vehicle to pedestrian (V2P) meaning a communication mode performed between a vehicle and a mobile terminal carried by a pedestrian.

Furthermore, in 3GPP, V2X has been studied that uses cellular communication and inter-terminal communication according to LTE or NR. It is assumed that, in V2X according to LTE or NR, a study that is not limited to the 3GPP specification will be progressed. For example, it is expected that the following items will be studied: ensuring interoperability; cost efficiency for implementing a higher layer; combining or switching multiple RATS (Radio Access Technologies); supporting regulation in each country; and data retrieving, delivering, database management, and use of a V2X platform according to LTE or NR.

In the embodiments of the present invention, a form in which the communication device is installed on a vehicle is mainly assumed, but embodiments of the present invention are not limited to this form. For example, the communication device may be a terminal carried by a person, the communication device may be a device installed in a drone or an aircraft, and the communication device may be a base station, an RSU, a relay station (relay node), a user equipment provided with scheduling capability, or the like.

Note that sidelink (SL) may be distinguished from uplink (UL) or downlink (DL) based on one of the following 1) to 4) or a combination thereof. Furthermore, SL may have any other name.

1) A resource allocation in a time domain

2) A resource allocation in a frequency domain

3) A synchronization signal to be referred to (including a sidelink synchronization signal (SLSS))

4) A reference signal used for path loss measurement for transmission power control.

Furthermore, for orthogonal frequency division multiplexing (OFDM) of SL or UL, any one of cyclic-prefix OFDM (CP-OFDM), discrete Fourier transform-spread-OFDM (DFT-S-OFDM), OFDM without transform precoding, and OFDM with transform precoding may be applied.

In SL of LTE, Mode 3 and Mode 4 are specified for SL resource allocation to the user equipment 20. In Mode 3, transmission resources are dynamically allocated in accordance with downlink control information (DCI) transmitted from the base station apparatus 10 to the user equipment 20. In Mode 3, semi persistent scheduling (SPS) can be performed as well. In Mode 4, the user equipment 20 autonomously selects transmission resources from a resource pool.

A slot in an embodiment of the present invention may be replaced with a mini slot, a subframe, a radio frame, a transmission time interval (TTI), or the like.

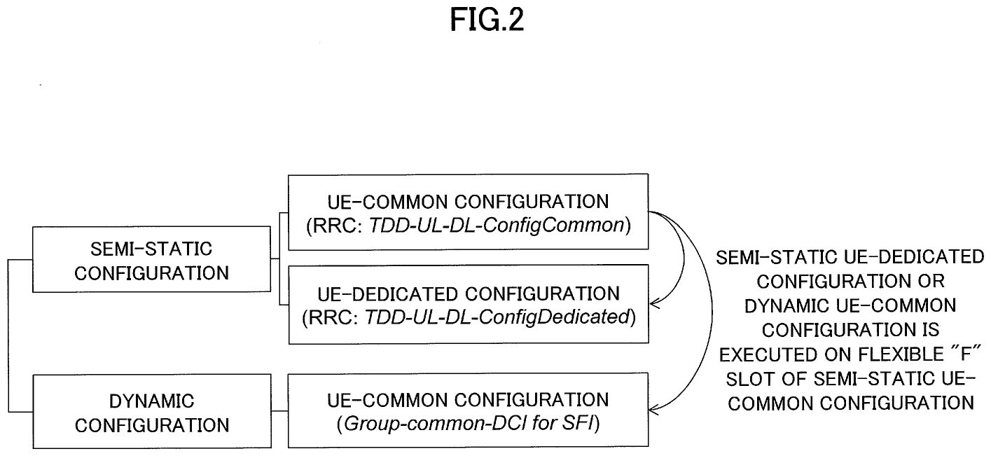

FIG. 2 is a diagram for illustrating an example of existing UL and DL resource configurations. As illustrated in FIG. 2, UL and DL resource configurations are semi-statically configured or dynamically configured. The semi-static configuration includes a UE-common configuration (a radio resource control (RRC) message: TDD-UL-DL-ConfigCommon) or a UE-dedicated configuration (an RRC message: TDD-UL-DL-ConfigDedicated). A dynamic configuration includes a UE-common configuration (Group-common-downlink control information (DCI) for slot format information (SFI)). For a semi-static UE-common flexible slot, a semi-static UE dedicated configuration or a dynamic UE-common configuration is configured. A flexible resource may be denoted as “F,” a DL resource may be denoted as “D,” and a UL resource may be denoted as “U.” A flexible resource is a resource that can be used for any one of UL, DL, and SL.

Here, a semi-static configuration and/or a dynamic configuration is supported for an SL resource, especially, when UL, DL, and SL are allocated in a common band. A dynamic configuration of SL can be executed depending on traffic or a load. For example, for a cell with large traffic, a traffic load can be changed per slot. Furthermore, for example, for event trigger-type traffic, an SL traffic load to be prioritized can be changed.

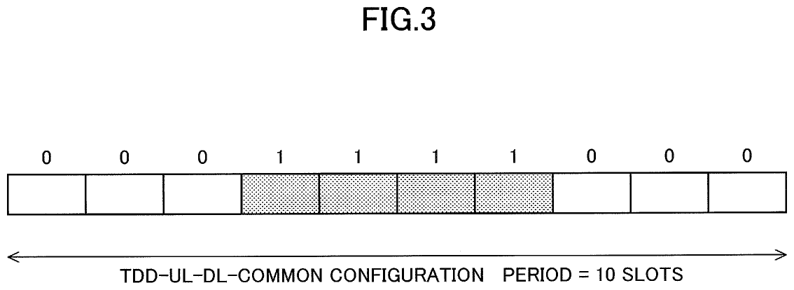

FIG. 3 is a diagram illustrating an example (1) of a resource configuration in an embodiment of the present invention. An SL resource can be configured by overwriting the resource on a UL resource, a DL resource and/or a flexible resource. An SL resource in a frequency domain may be configured similarly to a configuration of an SL resource of LTE. For example, a start PRB (Physical Resource Block) and a PRB length in the frequency domain are configured. Alternatively, a PRB common to a DL or UL resource may be used for SL. The user equipment 20 executes SL transmission using a configured SL resource.

An SL resource in a time domain may be configured by indicating a bitmap for a length that is N times as much as a period of a TDD-UL-DL common configuration. N is a non-negative integer. FIG. 2 is an example in which a 10-bit bitmap is indicated for a case in which a period of a TDD-UL-DL common configuration is 10 slots and N=1. A slot indicated by “1” is configured for SL, and a slot indicated by “0” is not configured for SL. In other words, if slot indexes are from 1 to 10, in the example of FIG. 2, SL resources are configured for the slot #4, the slot #5, the slot #6, and the slot #7.

A bitmap length may be predefined or configured. A bitmap length may be a length that is equal to N times as much as a period of a TDD-UL-DL common configuration. Furthermore, a fixed length may be predefined as a bitmap length. For example, a maximum of 80 bits or 160 bits may be predefined as a fixed length, and a part of the fixed length that exceeds a length that is N times as much as a period of a TDD-UL-DL common configuration may be truncated.

N may be predefined or configured. For example, N may be 1. Furthermore, N may be determined from a minimum or maximum bitmap length. For example, a bitmap length longer than the minimum bitmap length may be selected, or a bitmap length shorter than the maximum bitmap length may be selected. The minimum or maximum bitmap length may be predefined or configured. Note that one or more symbols may be excluded from SL resource allocation in a slot in which an SL resource is configured.

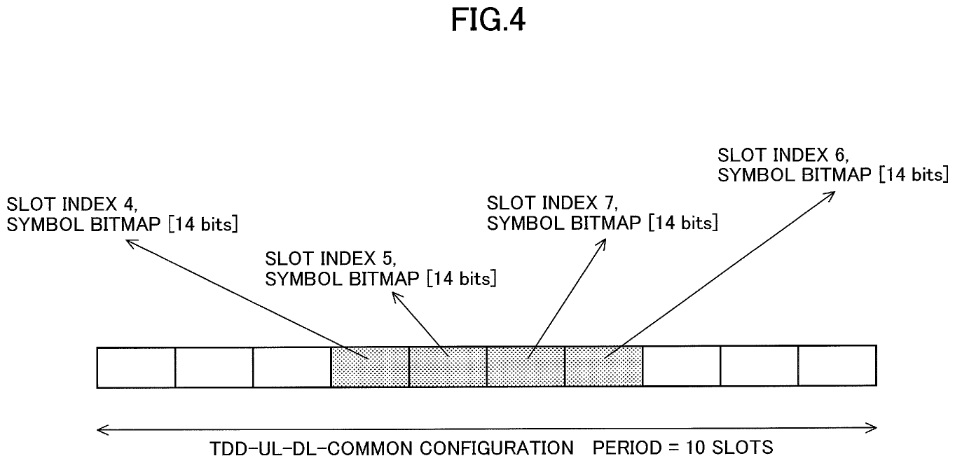

FIG. 4 is a diagram illustrating an example (2) of a resource configuration in an embodiment of the present invention. An SL resource configuration in units of symbols within a specific slot may be indicated by one or more slot indexes and a symbol bitmap less than or equal to a number of symbols in one slot. FIG. 4 is an example in which SL resources are indicated by 14-bit symbol bitmaps for the slot #4, the slot #5, the slot #6, and the slot #7, respectively. In FIG. 4, a case is assumed in which one slot consists of 14 symbols. However, the symbols are not limited to 14 symbols. For example, one slot may include more symbols than 14 symbols or less symbols than 14 symbols. A length of a symbol bitmap may be changed according to a number of symbols included in one slot. Furthermore, even if an indication with a symbol bitmap is made, a specific symbol may be excluded from SL resource allocation. For example, a symbol bitmap may be used that corresponds to a number of symbols obtained by excluding symbols that are DL resources included in one slot.

Furthermore, an SL resource configuration that is common in units of symbols within a slot may be indicated by a symbol bitmap that is common among a plurality of slots. For example, slots within one period of a TDD-UL-DL common configuration may be grouped into one or more groups, and a symbol bitmap may be configured for each group. For example, grouping may be made by setting a threshold value in slot indexes or may be made based on whether a slot index is an even number or an odd number. Alternatively, a symbol bitmap that is common among all the slots within a period of a TDD-UL-DL common configuration may be indicated.

Furthermore, for configuring an SL resource in a slot, a symbol bitmap may be used; a start symbol position and an end symbol position of the SL resource configuration may be indicated; a start symbol position and a length (a number of symbols) of the SL resource configuration may be indicated; or an end symbol position and a length (a number of symbols) of the SL resource configuration may be indicated. Note that an end symbol position may be a position from a beginning of the period or may be a position from an end of the period.

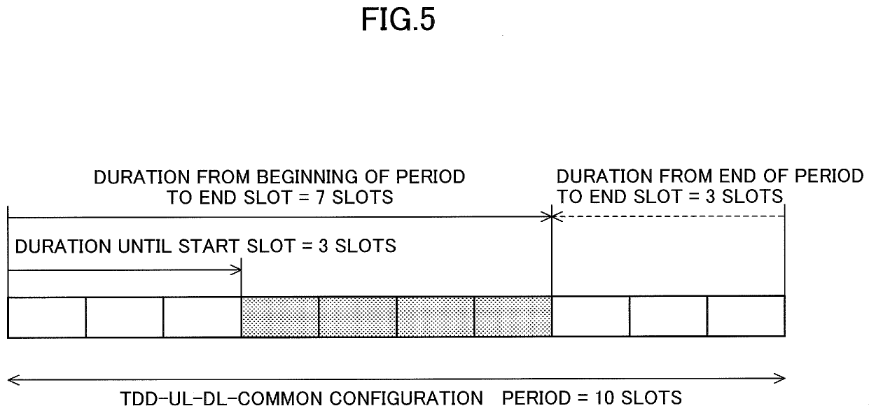

FIG. 5 is a diagram illustrating an example (3) of a resource configuration in an embodiment of the present invention. A length of an SL resource in the time domain may be indicated for each period of a TDD-UL-DL common configuration. A start slot and/or symbol of an SL resource may be configured or predefined. An end slot and/or symbol of an SL resource may be configured or predefined. A length (a number of slots or a number of symbols) from a start slot or symbol of an SL resource may be indicated. Note that one or more symbols may be excluded from SL resource allocation in a slot or symbol in which an SL resource is configured.

As illustrated in FIG. 5, a duration of three slots until a start slot and a duration of 7 slots from a beginning of a period to an end slot may be indicated. As illustrated in FIG. 5, instead of the duration of 7 slots from the beginning of the period to the end, a duration of three slots from the end of the period to the end slot may be indicated.

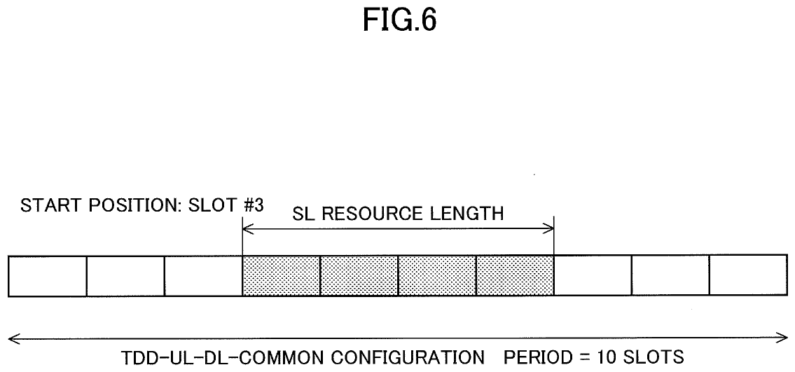

FIG. 6 is a diagram illustrating an example (4) of a resource configuration in an embodiment of the present invention. As illustrated in FIG. 6, a slot #3 as a start position of an SL resource and four slots as a length of the SL resource may be indicated.

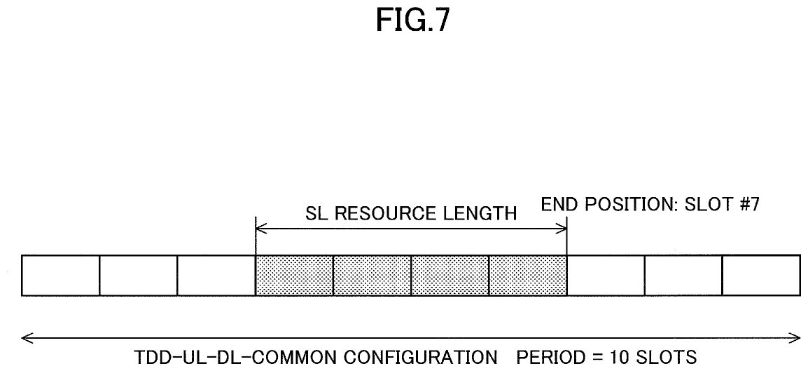

FIG. 7 is a diagram illustrating an example (5) of a resource configuration in an embodiment of the present invention. As illustrated in FIG. 7, a slot #7 as an end position of an SL resource and four slots as a length of the SL resource may be indicated.

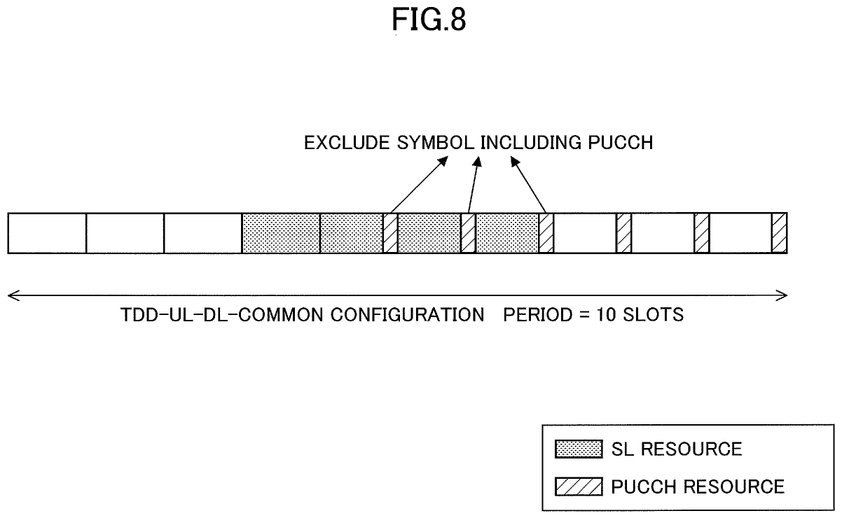

FIG. 8 is a diagram illustrating an example (6) of a resource configuration in an embodiment of the present invention. In FIG. 8, an example is illustrated that is a resource excluded from SL resource allocation. As illustrated in FIG. 8, a symbol allocated as a PUCCH (Physical Uplink Control Channel) may be excluded from SL resource allocation. The example of the SL resource exclusion described below, including FIG. 8, can be applied to the examples (1) through (5) of the resource configuration described using FIG. 3 through FIG. 7.

Additionally, symbols or slots in which the following resources are configured may be excluded from the SL resource allocation:

1) all DL resources

2) a DL resource for transmitting an SS, a physical broadcast channel (PBCH), remaining minimum system information (RMSI), or other system information (OSI);

3) a DL Resource for transmitting a physical downlink control channel (PDCCH);

4) an UL resource for transmitting a PUCCH;

5) an UL resource for transmitting a physical random access channel (PRACH); and

6) an UL resource for transmitting a sounding reference signal (SRS).

Furthermore, resources, symbols, or slots excluded from the SL resource allocation may be determined based on a resource configuration other than that of SL. A resource configuration other than that of SL is for example, a resource configuration of an SS, a PBCH, a RMSI, an OSI, a PRACH, a part of PDCCHs, and a part of PUCCHs. The user equipment 20 may exclude a part of resources or all the resources from the SL resource allocation based on the resource configurations other than that of SL.

Furthermore, resources, symbols, or slots excluded from the SL resource allocation may be signaled by a resource configuration indication. For example, when a PDCCH, a PUCCH, or an SRS resource configuration is indicated to the user equipment 20 through higher layer signaling or PHY layer signaling, the user equipment 20 may exclude a part of resources or all the resources from the SL resource allocation based on the resource configuration.

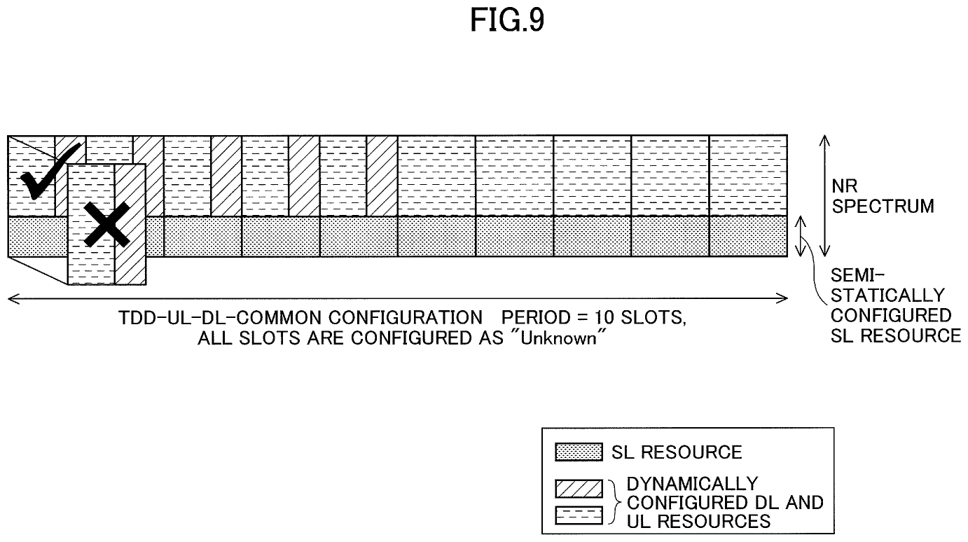

FIG. 9 is a diagram illustrating an example (7) of a resource configuration in an embodiment of the present invention. It may be configured or predefined as to whether a semi-static UE dedicated configuration and/or a dynamic configuration can overwrite an SL resource by a semi-static UE-common configuration. For example, as illustrated in FIG. 9, a dynamic configuration need not be prioritized over an SL resource by a semi-static UE common configuration. Furthermore, priority levels may be configured or predefined for a semi-static UE common configuration, a dynamic configuration, and a semi-static UE dedicated configuration, respectively.

Furthermore, a dynamic configuration may be supported such that an SL resource in a time domain is configured in units of slots and/or symbols. In order to configure an SL resource in units of slots and/or symbols, a method may be executed that is the same as those of the semi-static configurations described in the examples (1) to (6) of the resource configurations illustrated using FIG. 3 to FIG. 8. For example, slots and/or symbols that are available or unavailable for SL transmission may be indicated using a bitmap. Alternatively, a start position, an end position, or a length (a number of slots or a number of symbols) of a slot and/or a symbol that is available or unavailable for SL transmission may be indicated. The bitmap, the start position of the SL resource, the end position of the SL resource, the length of the SL resource, or the like may be indicated to the user equipment 20 by including the bitmap, the start position, the end position, or the length of the SL resource, or the like in DCI or SCI.

Furthermore, a dynamic configuration may include an “S” symbol indicating an SL resource as a new slot format. A number of SL symbols configured may depend on a slot format, and a number of SL symbols may be adjusted by changing a slot format by a dynamic configuration. Note that a part of “F” symbols or all the “F” symbols used for an existing slot format may be replaced with “S” symbols.

Furthermore, in a dynamic configuration, an SL resource may be indicated by a “F” symbol used in the existing slot format. It may be configured or predefined that an “F” symbol is used for an SL resource. For example, a configuration may be indicated through an additional bit of a group common DCI. Note that a number of “F” symbols included in a slot format can be configured.

For the above-described dynamic configuration, UE common signaling and/or UE dedicated signaling may be used for the notification. Furthermore, higher layer signaling and/or PHY layer signaling may be used for the notification. For example, the DCI, the SCI, media access control control element (MAC-CE)/header, or RRC signaling may be used for the notification. Furthermore, for example, group common DCI or group common SCI may be used for the notification.

A dynamic configuration of an SL resource in the frequency domain in units of slots may be supported. Furthermore, in a dynamic configuration of an SL resource in the frequency domain, the following may be dynamically configured: a start PRB or a start subcarrier; and a resource length in the frequency domain. Furthermore, a resource length in the frequency domain may be configured by an indication of a bandwidth part (BWP)-ID. For the above-described dynamic configuration of the SL resource in the frequency domain, UE common signaling and/or UE dedicated signaling may be used for the notification. Furthermore, higher layer signaling and/or PHY layer signaling may be used for the notification. For example, DCI or RRC signaling may be used for the notification. Furthermore, for example, group common DCI or group common SCI may be used for the notification.

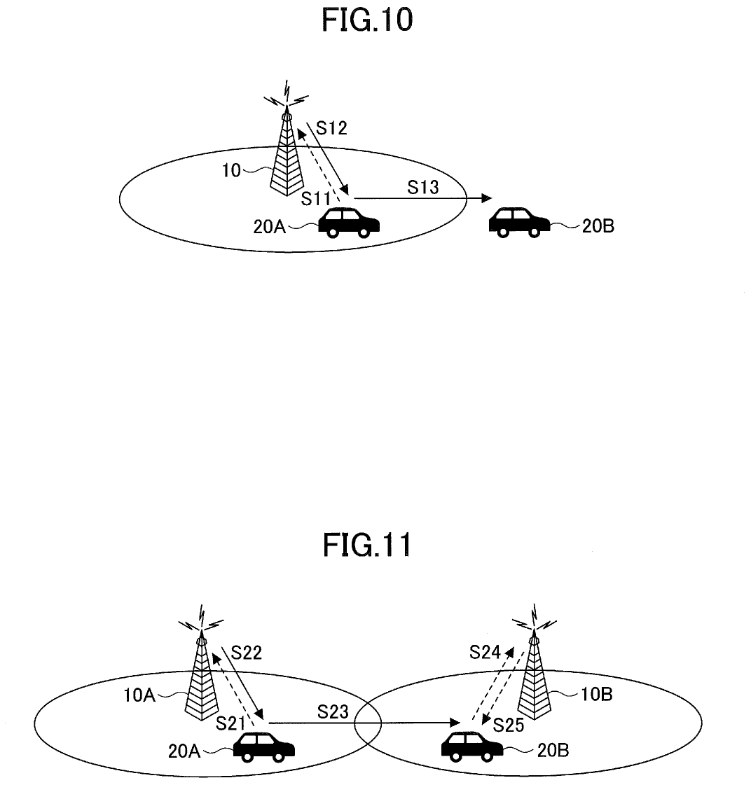

FIG. 10 is a diagram for illustrating an example (1) of a communication sequence in an embodiment of the present invention. A semi-static configuration and a dynamic configuration of SL may be relayed to the user equipment 20 in an out-of-service scenario for addressing cases of a neighboring cell and/or a partial coverage. A physical sidelink broadcast channel (PSBCH), a physical sidelink control channel (PSCCH), a physical sidelink shared channel (PSSCH), or a physical sidelink discovery channel (PSDCH) may be used for the relay.

A trigger for relaying of a semi-static configuration and a dynamic configuration of SL may be 1) to 3) described below:

1) a case in which a reference signal received power (RSRP), a received signal strength indicator (RSSI), a reference signal received quality (RSRQ), or a signal to noise interference ratio (SINR) is less than or higher than a predetermined threshold value in measurement of the user equipment 20A that executes the relay in a visited cell;

2) a case in which the RSRP, the RSSI, the RSRQ, or the SINR is less than or higher than a predetermined threshold value in the measurement of the user equipment 20B that receives an SL resource configuration in the visited cell; and

3) an instruction of the base station apparatus 10.

In step S11 illustrated in FIG. 10, the user equipment 20A transmits assistance information or a request for SL resource assignment or scheduling to the base station apparatus 10. The assistance information is, for example, a scheduling request (SR) or a buffer status report (BSR). Subsequently, in step S12, the base station apparatus 10 transmits the SL resource configuration to the user equipment 20A. Subsequently, the user equipment 20A relays the received SL resource configuration to the user equipment 20B. The user equipment 20B may be located outside of the base station apparatus 10. Note that the sequence may be started from step S12 without executing step S11.

FIG. 11 is a diagram for illustrating an example (2) of a communication sequence in an embodiment of the present invention. In step S21 illustrated in FIG. 11, the user equipment 20A transmits assistance information or a request for SL resource assignment or scheduling to the base station apparatus 10A. The assistance information is, for example, the SR or the BSR. Subsequently, in step S22, the base station apparatus 10A transmits the SL resource configuration to the user equipment 20A. Subsequently, in step S23, the user equipment 20A relays the received SL resource configuration to the user equipment 20B. The user equipment 20B may be located outside the base station apparatus 10. Subsequently, in step S24, the user equipment 20B transmits the relayed SL resource configuration to the base station apparatus 10B. Subsequently, in step S25, the base station apparatus 10B configures the SL resource for the user equipment 20B based on the received SL resource configuration.

According to the above-described embodiments, the user equipment 20 semi-statically configure or dynamically configure an SL resource in an NR band, and the user equipment can share the band of NR in the UL resource, in the DL resource, and in the SL resource.

In other words, in the inter-terminal direct communication, a resource to be used by the user equipment can be flexibly configured.

(Device Configuration)

Next, a functional configuration example of each of the base station apparatus 10 and the user equipment 20 that execute the processes and the operation described so far is described. Each of the base station apparatus 10 and the user equipment 20 has the function of implementing the embodiments. Here, each of the base station apparatus 10 and the user equipment 20 may have only some of the functions in the embodiments.

<Base Station Apparatus 10>

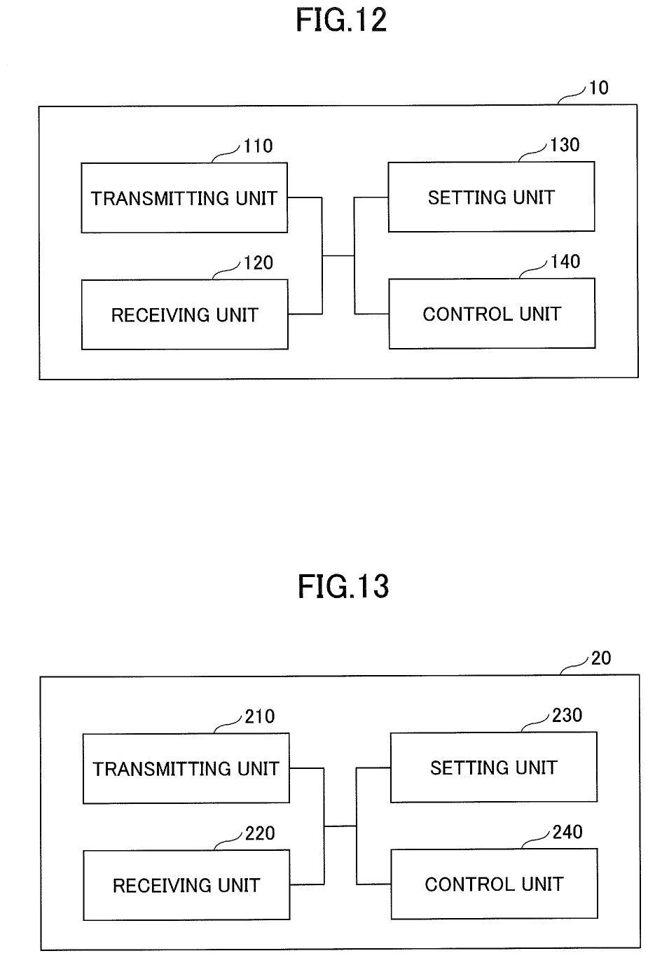

FIG. 12 is a diagram illustrating an example of a functional configuration of the base station apparatus 10. As illustrated in FIG. 12, the base station apparatus 10 has a transmitting unit 110, a receiving unit 120, a setting unit 130, and a control unit 140. The functional configuration illustrated in FIG. 12 is merely an example. As long as the operation according to the embodiments of the present invention can be executed, the functional classification and the name of the functional unit may be any classification and name.

The transmitting unit 110 has a function of generating a signal to be transmitted to the user equipment 20 and transmitting the signal wirelessly. The receiving unit 120 has a function of receiving various types of signals transmitted from the user equipment 20 and acquiring, for example, information of a higher layer from the received signals. The transmitting unit 110 has a function of transmitting the NR-PSS, the NR-SSS, the NR-PBCH, the DL/UL control signal, the DL reference signal or the like to the user equipment 20.

The setting unit 130 stores pre-configured configuration information and various types of configuration information to be transmitted to the user equipment 20 in the storage device and reads the configuration information from the storage device if necessary. For example, content of the configuration information is, for example, information related to a resource configuration of the D2D communication or the like.

As described in the embodiments, the control unit 140 performs a process related to the resource configuration used for the user equipment 20 to perform the D2D communication. The control unit 140 transmits, through the transmitting unit 110, a resource configuration for performing the D2D communication to the user equipment 20. A functional unit related to signal transmission in the control unit 140 may be included in the transmitting unit 110, and a functional unit related to signal reception in the control unit 140 may be included in the receiving unit 120.

<User Equipment 20>

FIG. 13 is a diagram illustrating an example of a functional configuration of the user equipment 20. As illustrated in FIG. 13, the user equipment 20 has a transmitting unit 210, a receiving unit 220, a setting unit 230, and a control unit 240. The functional configuration illustrated in FIG. 13 is merely an example. As long as the operation according to the embodiments of the present invention can be executed, the functional classification and the name of the functional unit may be any classification and name.

The transmitting unit 210 generates a transmission signal from transmission data and transmits the transmission signal wirelessly. The receiving unit 220 wirelessly receives various types of signals, and acquires a signal of a higher layer from a received signal of a physical layer. The receiving unit 220 also has a function of receiving the NR-PSS, the NR-SSS, the NR-PBCH, the DL/UL/SL control signal, a reference signal, or the like transmitted from the base station apparatus 10. Furthermore, for example, the transmitting unit 210 may transmit a physical sidelink control channel (PSCCH), a physical sidelink shared channel (PSSCH), a physical sidelink discovery channel (PSDCH), a physical sidelink broadcast channel (PSBCH), and the like to any other user equipment 20 as the D2D communication, and the receiving unit 220 receives the PSCCH, the PSSCH, the PSDCH, the PSBCH, and the like from any other user equipment 20.

The setting unit 230 stores various types of configuration information received from the base station apparatus 10 or the user equipment 20 through the receiving unit 220 in the storage device and reads the configuration information from the storage device if necessary. The setting unit 230 also stores pre-configured configuration information. For example, content of the configuration information is, for example, information related to the configuration of the D2D communication or the like.

As described in the embodiments, the control unit 240 controls D2D communication with another user equipment 20. Furthermore, the control unit 240 transmits, through the transmitting unit 210, information on a resource configuration of the D2D communication to another user equipment 20 through the transmitting unit 210. A functional unit related to signal transmission in the control unit 240 may be included in the transmitting unit 210, and a functional unit related to signal reception in the control unit 240 may be included in the receiving unit 220.

<Hardware Configuration>

The block diagrams (FIG. 12 and FIG. 13) used for the description of the above embodiments illustrate blocks of functional units. These functional blocks (components) are implemented by any combination of at least one of hardware and software. In addition, the implementation method of each functional block is not particularly limited. That is, each functional block may be implemented using a single device that is physically or logically combined, or may be implemented by directly or indirectly connecting two or more devices that are physically or logically separated (e.g., using wire, radio, etc.) and using these multiple devices. The functional block may be implemented by combining software with the above-described one device or the above-described plurality of devices.

Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, etc. For example, a functional block (component) that functions to transmit is called a transmitting unit or a transmitter. In either case, as described above, the implementation method is not particularly limited.

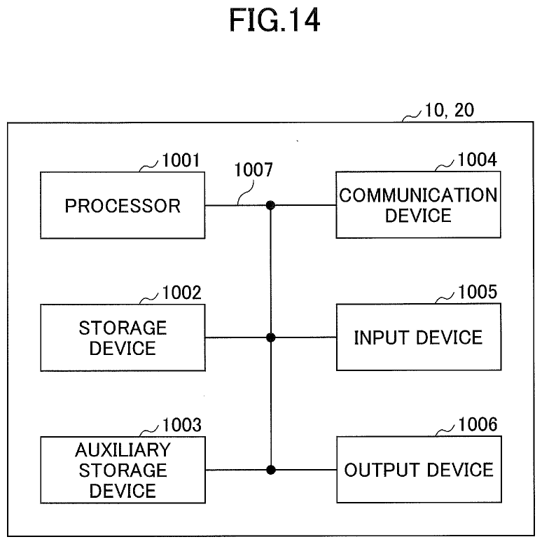

For example, the base station apparatus 10, the user equipment 20, or the like in an embodiment of the present invention may function as a computer for performing a process of radio communication method according to the present disclosure. FIG. 14 is a diagram illustrating an example of a hardware configuration of the base station apparatus 10 and the user equipment 20 according to an embodiment of the present disclosure. Each of the base station apparatus 10 and the user equipment 20 described above may be physically configured as a computer device including a processor 1001, a storage device 1002, an auxiliary storage device 1003, a communication apparatus 1004, an input device 1005, an output apparatus 1006, a bus 1007, and the like.

In the following description, the term “device” can be read as a circuit, device, unit, or the like. The hardware configuration of each of the base station apparatus 10 and the user equipment 20 may be configured to include each device depicted, or may be configured without including some devices.

Each function in each of the base station apparatus 10 and the user equipment 20 is implemented such that predetermined software (program) is read on hardware such as the processor 1001, the storage device 1002 and the like, and the processor 1001 performs an operation and controls communication by the communication apparatus 1004 and at least one of reading and writing of data in the storage device 1002 and the auxiliary storage device 1003.

For example, the processor 1001 operates an operating system and controls the entire computer. The processor 1001 may be configured with a central processing unit (CPU) including an interface with a peripheral device, a control device, an operation device, a register, and the like. For example, the above-described control unit 140, the control unit 240, and the like may be implemented by the processor 1001.

Furthermore, the processor 1001 reads a program (program code), a software module, data, or the like from at least one of the auxiliary storage device 1003 and the communication apparatus 1004 out to the storage device 1002, and executes various types of processes according to them. A program causing a computer to execute at least some of the operations described in the above embodiments is used as the program. For example, the control unit 140 of the base station apparatus 10 illustrated in FIG. 12 may be implemented by a control program which is stored in the storage device 1002 and operates on the processor 1001. Furthermore, for example, the control unit 240 of the user equipment 20 illustrated in FIG. 13 may be implemented by a control program which is stored in the storage device 1002 and operates on the processor 1001. Various types of processes are described to be executed by one processor 1001 but may be executed simultaneously or sequentially by two or more processors 1001. The processor 1001 may be implemented by one or more chips. The program may be transmitted from a network via an electric communication line.

The storage device 1002 is a computer readable recording medium and configured with at least one of a read only memory (ROM), an erasable programmable ROM (EPROM), an electrically erasable programmable ROM (EEPROM), a random access memory (RAM), and the like. The storage device 1002 is also referred to as a “register,” a “cache,” a “main memory,” or the like. The storage device 1002 can store programs (program codes), software modules, or the like which are executable for carrying out the communication method according to an embodiment of the present disclosure.

The auxiliary storage device 1003 is a computer-readable recording medium and may be configured with, for example, at least one of an optical disk such as a compact disc ROM (CD-ROM), a hard disk drive, a flexible disk, a magneto-optical disk (for example, a compact disk, a digital versatile disk, or a Blu-ray (registered trademark) disc, a smart card, a flash memory (for example, a card, a stick, or a key drive), a floppy (registered trademark) disk, a magnetic strip, and the like. The auxiliary storage device 1003 is also referred to as an “auxiliary storage device.” The above-described storage medium may be, for example, a database, a server, or any other appropriate medium including at least one of the storage device 1002 and the auxiliary storage device 1003.

The communication apparatus 1004 is hardware (a transmitting and receiving device) for performing communication between computers via at least one of a wired network and a wireless network and is also referred to as a “network device,” a “network controller,” a “network card,” a “communication module,” or the like. The communication apparatus 1004 may be configured to include a high frequency switch, a duplexer, a filter, a frequency synthesizer, and the like to implement at least one of frequency division duplex (FDD) and time division duplex (TDD). For example, transmitting and receiving antennas, an amplifier, a transceiver, a transmission line interface, and the like may be implemented by the communication apparatus 1004. The transceiver may be implemented such that a transmitter and a receiver are physically or logically separated.

The input device 1005 is an input device that receives an input from the outside (such as a keyboard, a mouse, a microphone, a switch, a button, a sensor, or the like). The output apparatus 1006 is an output device that performs an output to the outside (for example, a display, a speaker, an LED lamp, or the like). The input device 1005 and the output apparatus 1006 may be integrally configured (for example, a touch panel).

The respective devices such as the processor 1001 and the storage device 1002 are connected by the bus 1007 to communicate information with each other. The bus 1007 may be configured with a single bus or may be configured with different buses between the devices.

Furthermore, each of the base station apparatus 10 and the user equipment 20 may be configured to include hardware such as a microprocessor, a digital signal processor (DSP), an application specific integrated circuit (ASIC), a programmable logic device (PLD), or a field programmable gate array (FPGA), or all or some of the functional blocks may be implemented by hardware. For example, the processor 1001 may be implemented by at least one of these pieces of hardware.

### CONCLUSION OF THE EMBODIMENTS

As described above, according to the embodiment, there is provided a user equipment including a receiving unit that receives information indicating a resource to be used for inter-terminal direct communication; and a transmitting unit that executes a transmission in the inter-terminal direct communication based on the information indicating the resource, wherein the information indicating the resource is a semi-static UE (User Equipment) dedicated configuration or a dynamic configuration that includes information in which the resource to be used for the inter-terminal direct communication is overwritten on an uplink resource or a flexible resource that is to be time division multiplexed in a semi-static UE common configuration.

With the above-described configuration, the user equipment 20 can semi-statically configure or dynamically configure an SL resource in an NR band, and the NR band can be shared among a UL resource, a DL resource and the SL resource. Namely, a resource to be used by the user equipment can be flexibly configured in inter-terminal direct communication.

The semi-static UE dedicated configuration may specify the resource to be used for the inter-terminal direct communication by a bitmap corresponding to a period that is an integral multiple of a period of the semi-static UE common configuration. With this configuration, the user equipment 20 can efficiently overwrite a semi-static UE dedicated configuration on a semi-static UE common configuration.

Within the resource used for the inter-terminal direct communication specified by the semi-static UE dedicated configuration, all downlink resources, a downlink resource including a synchronization signal or system information, a downlink resource including a PDCCH (Physical Downlink Control Channel), an uplink resource including a PUCCH (Physical Uplink Control Channel), an uplink resource including a PRACH (Physical Random Access Channel), or an uplink resource including an SRS (Sounding Reference Signal) may be excluded from the resource used for the inter-terminal direct communication. With this configuration, the user equipment 20 can precede downlink communication or uplink communication over sidelink communication.

The dynamic configuration may include information for changing a slot format among a plurality of slot formats that differ in a number of symbols to be used in the inter-terminal direct communication, and the dynamic configuration is indicated by PHY layer signaling using DCI (Downlink control information) or SCI (Sidelink control information). With this configuration, the user equipment 20 can dynamically change a number of symbols of sidelink communication by PHY layer signaling so as to follow a communication situation.

A control unit may further be included that relays, to another user equipment, the semi-static UE dedicated configuration or the dynamic configuration. With this configuration, by indicating, by the user equipment 20, a sidelink resource configuration to another user equipment located outside coverage, an area can be extended in which the base station apparatus 10 controls the sidelink communication.

Furthermore, according to the embodiments of the present invention, there is provided a base station apparatus including a transmitting unit that transmits information indicating a resource used for inter-terminal direct communication; and a control unit that controls the inter-terminal direct communication based on the information indicating the resource, wherein the information indicating the resource is a semi-static UE (User Equipment) dedicated configuration or a dynamic configuration that includes information in which the resource used for the inter-terminal direct communication is overwritten on an uplink resource or a flexible resource that is time division multiplexed in a semi-static UE common configuration.

With the above-described configuration, the base station apparatus 10 can semi-statically configure or dynamically configure an SL resource in an NR band for the user equipment 20, and the NR band can be shared among a UL resource, a DL resource and the SL resource. Namely, a resource to be used by the user equipment can be flexibly configured in inter-terminal direct communication.

### SUPPLEMENTAL EMBODIMENT

The exemplary embodiment of the present invention has been described above, but the disclosed invention is not limited to the above embodiments, and those skilled in the art would understand various modified examples, revised examples, alternative examples, substitution examples, and the like. In order to facilitate understanding of the invention, specific numerical value examples have been used for description, but the numerical values are merely examples, and certain suitable values may be used unless otherwise stated. The classification of items in the above description is not essential to the present invention. Matters described in two or more items may be combined and used if necessary, and a matter described in one item may be applied to a matter described in another item (unless inconsistent). The boundary between functional units or processing units in a functional block diagram does not necessarily correspond to the boundary between physical parts. Operations of a plurality of functional units may be performed physically by one component, or an operation of one functional unit may be physically performed by a plurality of parts. In the processing procedure described in the embodiments, the order of the processes may be changed as long as there is no inconsistency. For the sake of convenience of processing description, the base station apparatus 10 and the user equipment 20 have been described using the functional block diagrams, but such devices may be implemented by hardware, software, or a combination thereof. Software executed by the processor included in the base station apparatus 10 according to the embodiment of the present invention and software executed by the processor included in the user equipment 20 according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

Furthermore, a notification of information is not limited to the aspect or embodiment described in the present disclosure and may be provided by any other method. For example, the notification of information may be given by physical layer signaling (for example, downlink control information (DCI) or uplink control information (UCI)), upper layer signaling (for example, radio resource control (RRC) signaling, medium access control (MAC) signaling, broadcast information (master information block (MIB), system information block (SIB)), other signals, or a combination thereof. Furthermore, the RRC signaling may be referred to as an RRC message and may be, for example, an RRC connection setup message, an RRC connection reconfiguration message, or the like.

Each aspect and embodiment described in the present disclosure may be applied to at least one of Long Term Evolution (LTE), LTE-advanced (LTE-A), SUPER 3G, IMT-advanced, 4G (4th generation mobile communication system), 5G (5th generation mobile communication system), Future Radio Access (FRA), NR (new Radio), W-CDMA (registered trademark), GSM (registered trademark), CDMA 2000, Ultra Mobile Broadband (UMB), IEEE 802.11 (Wi-Fi(registered trademark)), IEEE 802.16 (WiMAX(registered trademark)), IEEE 802.20, Ultra-WideBand (UWB), Bluetooth (registered trademark), a system using any other appropriate system, and next generation systems extended based on these standards. Furthermore, a plurality of systems (e.g., a combination of at least one of LTE and LTE-A with 5G) may be combined to be applied.

The processing procedures, the sequences, the flowcharts, and the like of the respective aspects/embodiments described in this specification may be reversed in order provided that there is no contradiction. For example, the method described in the present disclosure presents elements of various steps with an exemplary order and is not limited to a presented specific order.

In this specification, a specific operation to be performed by the base station apparatus 10 may be performed by an upper node in some cases. In the network including one or more network nodes including the base station apparatus 10, various operations performed for communication with the user equipment 20 can be obviously performed by at least one of the base station apparatus 10 and any network node (for example, an MME, an S-GW, or the like is considered, but it is not limited thereto) other than the base station apparatus 10. A case is exemplified above in which there is one network node other than the base station apparatus 10. The one network node may be a combination of a plurality of other network nodes (e.g., MME and S-GW).

Information, a signal, or the like described in the present disclosure may be output from an upper layer (or a lower layer) to a lower layer (or an upper layer). Information, a signal, or the like described in the present disclosure may be input and output via a plurality of network nodes.

Input and output information and the like may be stored in a specific place (for example, a memory) or may be managed through a management table. Input and output information and the like may be overwritten, updated, or additionally written. Output information and the like may be deleted. Input information and the like may be transmitted to another device.

The determination the present disclosure may be performed in accordance with a value (0 or 1) indicated by one bit, may be performed in accordance with a Boolean value (true or false), or may be performed by a comparison of numerical values (for example, a comparison with a predetermined value).

Software can be interpreted widely to mean a command, a command set, a code, a code segment, a program code, a program, a subprogram, a software module, an application, a software application, a software package, a routine, a subroutine, an object, an executable file, an execution thread, a procedure, a function, and the like regardless of whether software is called software, firmware, middleware, a microcode, a hardware description language, or any other name.

Further, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL)) and a radio technology (such as infrared rays or a microwave), at least one of the wired technology and the radio technology are included in a definition of a transmission medium.

Information, signals, and the like described in this disclosure may be indicated using any one of a variety of different techniques. For example, data, instructions, commands, information, signals, bits, symbols, chips, and the like which are mentioned throughout the above description may be indicated by voltages, currents, electromagnetic waves, magnetic particles, optical fields or photons, or any combination thereof.

The terms described in the present disclosure and terms necessary for understanding the present disclosure may be replaced with terms having the same or similar meanings. For example, at least one of a channel and a symbol may be a signal. Further, a signal may be a message. Further, a component carrier (CC) may be referred to as a “carrier frequency,” a “cell,” or the like.

The terms “system” and “network” used in the present disclosure are used interchangeably.

Further, information, parameters, and the like described in the present disclosure may be indicated by absolute values, may be indicated by relative values from predetermined values, or may be indicated by corresponding other information. For example, radio resources may be those indicated by an index.

The names used for the above-described parameters are not limited in any respect. Further, mathematical formulas or the like using the parameters may be different from those explicitly disclosed in the present disclosure. Since various channels (for example, a PUCCH, a PDCCH, and the like) and information elements can be identified by suitable names, various names assigned to the various channels and the information elements are not limited in any respect.

In the present disclosure, the terms “base station (BS),” “radio base station,” “base station apparatus,” “fixed station,” “Node B,” “eNode B (eNB),” “gNodeB (gNB),” “access point,” “transmission point,” “reception point,” “transmission/reception point,” “cell,” “sector,” “cell group,” “carrier,” “component carrier,” and the like can be used interchangeably. The base stations may also be indicated by terms such as a macrocell, a small cell, a femtocell, and a picocell.

The base station eNB can accommodate one or more (for example, three) cells. In a case in which the base station accommodates a plurality of cells, the entire coverage area of the base station can be partitioned into a plurality of small areas, and each small area can provide a communication service through a base station subsystem (for example, a small indoor base station (a remote radio head (RRH)). The term “cell” or “sector” refers to the whole or a part of the coverage area of at least one of the base station and the base station subsystem that performs a communication service in the coverage.

In the present disclosure, the terms “mobile station (MS),” “user terminal,” “user equipment (UE),” “terminal,” and the like can be used interchangeably.

The mobile station may be referred to, by a person ordinarily skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

At least one of the base station and the mobile station may be also referred to as a transmitting device, a receiving device, a communication device, or the like. At least one of the base station and the mobile station may be a device installed in a mobile body, a mobile body itself, or the like. The mobile body may be a vehicle (for example, a car, an airplane, or the like), an unmanned body that moves (for example, a drone, an autonomous car or the like), or a robot (manned type or unmanned type). At least one of the base station and the mobile station includes a device which need not necessarily move during a communication operation. For example, at least one of the base station and the mobile station may be an Internet of things (IoT) device such as a sensor.

Further, the base station in the present disclosure may be replaced with a user terminal. For example, each aspect/embodiment of the present disclosure may be applied to a configuration in which communication between the base station and the user terminal is replaced with communication between a plurality of user terminals (for example, which may be referred to as device-to-device (D2D) or vehicle-to-everything (V2X)). In this case, the user terminal may have the functions of the base station described above. Further, the terms “uplink” and “downlink” may be replaced with terms (for example, “side”) corresponding to inter-terminal communication. For example, an uplink channel, a downlink channel, or the like may be read with side channels.

Similarly, the user terminal in the present disclosure may be replaced with the base station. In this case, the base station may have the functions of the above-mentioned user terminal.

The term “determining” used in this specification may include a wide variety of actions. For example, “determining” may include, for example, events in which events such as judging, calculating, computing, processing, deriving, investigating, looking up, search, and inquiry (for example, looking up in a table, a database, or another data structure), or ascertaining are regarded as “determining.” Further, “determining” may include, for example, events in which events such as receiving (for example, receiving information), transmitting (for example, transmitting information), input, output, or accessing (for example, accessing data in a memory) are regarded as “determining.” Further, “determining” may include, for example, events in which events such as resolving, selecting, choosing, establishing, or comparing are regarded as “determining.” In other words, “determining” may include events in which a certain operation is regarded as “determining.” Further, “determining” may be replaced with “assuming,” “expecting,” “considering,” or the like.

Terms “connected,” “coupled,” or variations thereof means any direct or indirect connection or coupling between two or more elements and may include the presence of one or more intermediate elements between two elements which are “connected” or “coupled.” The coupling or the connection between the elements may be physical, logical, or a combination thereof. For example, “connection” may be replaced with “access.” In a case in which used in the present disclosure, two elements may be considered to be “connected” or “coupled” with each other using at least one of one or more electric wires, cables and/or a printed electrical connection or using electromagnetic energy having a wavelength in a radio frequency domain, a microwave region, or a light (both visible and invisible) region as non-limiting and non-exhaustive examples.

A reference signal may be abbreviated as RS and may be referred to as a pilot, depending on a standard to be applied.

A phrase “based on” used in the present disclosure is not limited to “based only on” unless otherwise stated. In other words, a phrase “based on” means both “based only on” and “based on at least.”

Any reference to an element using a designation such as “first,” “second,” or the like used in the present disclosure does not generally restrict quantities or an order of those elements. Such designations can be used in the present disclosure as a convenient method of distinguishing two or more elements. Thus, reference to the first and second elements does not mean that only two elements can be adopted there, or the first element must precede the second element in a certain form.

Further, “means” in the configuration of each of the above devices may be replaced with “unit,” “circuit,” “device,” or the like.

In a case in which “include,” “including,” and variations thereof are used in the present disclosure, these terms are intended to be comprehensive, similar to a term “provided with (comprising).” Further, the term “or” used in the present disclosure is intended not to be an exclusive OR.

A radio frame may include one or more frames in the time domain. In the time domain, each of one or more frames may be referred to as a sub frame. The sub frame may further include one or more slots in the time domain. The sub frame may have a fixed time length (for example, 1 ms) not depending on numerology.

The numerology may be a communication parameter applied to at least one of transmission and reception of a certain signal or channel. For example, the numerology may indicate at least one of a sub carrier spacing (SCS), a bandwidth, a symbol length, a cyclic prefix length, a transmission time interval (TTI), a number of symbols per TTI, a radio frame configuration, a specific filtering process performed in the frequency domain by a transceiver, a specific windowing process performed in the time domain by a transceiver, and the like.

The slot may include one or more symbols (orthogonal frequency division multiplexing (OFDM) symbols, single carrier frequency division multiple access (SC-FDMA) symbols, or the like) in the time domain. The slot may be a time unit based on the numerology.

The slot may include a plurality of mini slots. Each mini slot may include one or more symbols in the time domain. Further, the mini slot may be referred to as a sub-slot. The mini slot may include fewer symbols than a slot. A PDSCH (or PUSCH) transmitted in units of times greater than the mini slot may be referred to as a PDSCH (or PUSCH) mapping type A. A PDSCH (or PUSCH) transmitted using a mini slot may be referred to as a PDSCH (or PUSCH) mapping type B.

All of a radio frame, a sub frame, a slot, a mini slot, and a symbol indicates a time unit for transmitting a signal. As a radio frame, a sub frame, a slot, a mini slot, and a symbol, different designations respectively corresponding to them may be used.

For example, one subframe may be referred to as a transmission time interval (TTI: Transmission Time Interval), or a plurality of consecutive subframes may be referred to as TTIs, or one slot or one mini slot may be referred to as a TTI. In other words, at least one of the subframe and the TTI may be a subframe (1 ms) in the existing LTE, may be a duration shorter than 1 ms (for example, 1 to 13 symbols), or may be referred to as a duration longer than 1 ms. A unit representing the TTI may be referred to as slot, a mini slot, or the like instead of the sub frame.

Here, for example, the TTI refers to a minimum time unit of scheduling in wireless communication. For example, in the LTE system, the base station performs scheduling of allocating a radio resource (a frequency bandwidth, a transmission power, or the like which can be used in each user equipment 20) to each user equipment 20 in units of TTIs. The definition of the TTI is not limited thereto.

The TTI may be a transmission time unit such as a channel coded data packet (transport block), a code block, or a code word, or may be a processing unit such as scheduling or link adaptation. Further, when a TTI is given, a time interval (for example, the number of symbols) in which a transport block, a code block, a code word, or the like is actually mapped may be shorter than the TTI.

Further, when one slot or one mini slot is referred to as a TTI, one or more TTIs (that is, one or more slots or one or more mini slots) may be a minimum time unit of scheduling. Further, the number of slots (the number of mini slots) constituting the minimum time unit of scheduling may be controlled.

A TTI having a time length of 1 ms may be referred to as a common TTI (TTI in LTE Rel. 8 to 12), a normal TTI, a long TTI, a common sub frame, a normal sub frame, a long sub frame, a slot, or the like. A TTI shorter than the common TTI may be referred to as a reduced TTI, a short TTI, a partial TTI (a partial or fractional TTI), a reduced sub frame, a short sub frame, a mini slot, a sub slot, a slot, or the like.

Further, a long TTI (for example, a common TTI, a sub frame, or the like) may be replaced with a TTI having a time length exceeding 1 ms, and a short TTI (for example, a reduced TTI or the like) may be replaced with a TTI having a TTI length which is less than a TTI length of a long TTI and equal to or more than 1 ms.

The resource block (RB) is a resource allocation unit in the time domain and the frequency domain and may include one or more consecutive subcarriers in the frequency domain. The number of sub carriers included in an RB may be the same irrespective of a numerology and may be, for example, 12. The number of sub carriers included in an RB may be determined based on a numerology.

Further, a time domain of an RB may include one or more symbols and may be a length of one slot, one mini slot, one sub frame, or one TTI. Each of one TTI, one sub frame, or the like may be constituted by one or more resource blocks.

Further, one or more RBs may be referred to as a physical resource block (PRB), a sub carrier group (SCG), a resource element group (REG), a PRB pair, or the like.

Further, the resource block may be constituted by one or more resource elements (RE). For example, one RE may be a radio resource region of one subcarrier and one symbol.

A bandwidth part (BWP) (which may be referred to as a partial bandwidth) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include a BWP for UL (UL BWP) and a BWP for DL (DL BWP). In a UE, one or more BWPs may be configured within one carrier.

At least one of configured BWPs may be active, and it may not be assumed that the UE transmits and receives a predetermined signal/channel outside an active BWP. Further, a “cell,” a “carrier,” or the like in the present disclosure may be replaced with a “BWP.”

Structures of the radio frame, the sub frame, slot, the mini slot, and the symbol are merely examples. For example, configurations such as the number of sub frames included in a radio frame, the number of slots per sub frame or radio frame, the number of mini slots included in a slot, the number of symbols and RBs included in a slot or a mini slot, the number of sub carriers included in an RB, the number of symbols in a TTI, a symbol length, a cyclic prefix (CP) length, and the like can be variously changed.

In the entire present disclosure, for example, when an article such as “a,” “an,” or “the” in English is added by a translation, the present disclosure may include a case in which a noun following the article is the plural.

In the present disclosure, a term “A and B are different” may mean “A and B are different from each other.” Further, the term may mean “each of A and B is different from C.” Terms such as “separated,” “coupled,” or the like may also be interpreted in similarly to “different.”

Each aspect/embodiment described in this specification may be used alone, in combination, or may be switched in accordance with the execution. Further, notification of predetermined information (for example, notification of “being X”) is not limited to being performed explicitly, but is performed by implicit (for example, not notifying the predetermined information) It is also good.

Although the present disclosure is described above in detail, it is obvious to those skilled in the art that the present disclosure is not limited to the embodiments described in the present disclosure. The present disclosure may be implemented as revised and modified embodiments without departing from the gist and scope of the present disclosure as set forth in claims. Accordingly, the description of the present disclosure is for the purpose of illustration and does not have any restrictive meaning to the present disclosure.

### LIST OF REFERENCE SYMBOLS

10 base station apparatus
110 transmitting unit
120 receiving unit
130 setting unit
140 control unit
20 user equipment
210 transmitting unit
220 receiving unit
230 setting unit
240 control unit
1001 processor
1002 storage device
1003 auxiliary storage device
1004 communication device
1005 input device
1006 output device

1. A user equipment comprising:
a receiving unit that receives information indicating a resource to be used for inter-terminal direct communication; and
a transmitting unit that executes a transmission in the inter-terminal direct communication based on the information indicating the resource,
wherein the information indicating the resource is a semi-static UE (User Equipment) dedicated configuration or a dynamic configuration that includes information in which the resource to be used for the inter-terminal direct communication is overwritten on an uplink resource or a flexible resource that is to be time division multiplexed in a semi-static UE common configuration.

2. The user equipment according to claim 1, wherein the semi-static UE dedicated configuration specifies the resource to be used for the inter-terminal direct communication by a bitmap corresponding to a period that is an integral multiple of a period of the semi-static UE common configuration.

3. The user equipment according to claim 1, wherein, within the resource used for the inter-terminal direct communication specified by the semi-static UE dedicated configuration,
all downlink resources,
a downlink resource including a synchronization signal or system information,
a downlink resource including a PDCCH (Physical Downlink Control Channel),
an uplink resource including a PUCCH (Physical Uplink Control Channel),
an uplink resource including a PRACH (Physical Random Access Channel), or
an uplink resource including an SRS (Sounding Reference Signal) is excluded from the resource used for the inter-terminal direct communication.

4. The user equipment according to claim 1, wherein the dynamic configuration includes information for changing a slot format among a plurality of slot formats that differ in a number of symbols to be used in the inter-terminal direct communication, and the dynamic configuration is indicated by PHY layer signaling using DCI (Downlink control information) or SCI (Sidelink control information).

5. The user equipment according to claim 1, further comprising:
a control unit that relays, to another user equipment, the semi-static UE dedicated configuration or the dynamic configuration.

6. A base station apparatus comprising:
a transmitting unit that transmits information indicating a resource used for inter-terminal direct communication; and
a control unit that controls the inter-terminal direct communication based on the information indicating the resource,
wherein the information indicating the resource is a semi-static UE (User Equipment) dedicated configuration or a dynamic configuration that includes information in which the resource used for the inter-terminal direct communication is overwritten on an uplink resource or a flexible resource that is time division multiplexed in a semi-static UE common configuration.
